(19) United States
(12) Patent Application Publication
(10) Pub. No.: US 2022/0410439 A1
(43) Pub. Date: Dec. 29, 2022

(54) TRANSFER FILM FOR TRANSFERRING COATING MATERIALS TO COMPONENTS

(71) Applicant: Loparex Germany GmbH & Co. KG, Forchheim (DE)

(72) Inventor: Peter Kunzelmann, Erlangen (DE)

(21) Appl. No.: 17/773,903

(22) PCT Filed: Nov. 11, 2020
(86) PCT No.: PCT/EP2020/081733

§ 371 Date: May 3, 2022

(30) Foreign Application Priority Data
Nov. 14, 2019 (DE) 10 2019 217 560.0

(51) Int. Cl. B29C 33/56; B29C 51/14; B32B 7/10; B32B 27/22; B32B 27/08; B32B 27/32

(52) U.S. Cl. CPC B29C 33/56; B29C 51/14; B32B 7/10; B32B 27/22; B32B 27/08; B32B 27/32; B29L 2009/005

(57) ABSTRACT

The invention relates to a polymeric film for coating plastics mouldings with a coating material, the polymeric film comprising an adhesion-modified layer and also a layer of the coating material; where the polymeric film together with the adhesion-modified layer and the layer of the coating material is formable at room temperature; where the coating material wholly or partly covers the adhesion-modified layer; and where the adhesion-modified layer has a layer thickness of at least 0.1 μm; and where the adhesion-modified layer is in direct contact with the coating material. The invention further relates to uses of the polymeric film of the invention, to methods for its production and to methods for coating components using the polymeric film of the invention.

### CLAIM OF PRIORITY

This application is a national phase filing under 35 USC § 371 from International (PCT) Patent Application serial number PCT/DE2020/081733 filed on Nov. 11, 2020 and claims priority therefrom. This application further claims priority to German Patent Application Number DE 10 2019 217 560.0 filed on Nov. 14, 2019. International Patent Application number PCT/DE2020/081733 and German Patent Application number DE 10 2019 217 560.0 are each incorporated herein by reference in its entirety.

### FIELD

The invention relates to a polymeric film for coating plastics moldings with a coating material, where the polymeric film comprises an adhesion-modified layer and a layer of coating material; where the polymeric film together with the adhesion-modified layer and the layer of the coating material is formable at room temperature; where the coating material wholly or partly covers the adhesion-modified layer; and where the adhesion-modified layer has a layer thickness of at least 1.0 μm; and where the adhesion-modified layer is in direct contact with the coating material. The invention further relates to uses of the polymeric film of the invention, to methods for producing it and to methods for coating components using the polymeric film of the invention.

### BACKGROUND

Molded fiber composite components and other plastics moldings, such as those composed of polyurethane foams, for example, are frequently produced using vacuum infusion methods or resin transfer molding methods. In these methods a plastics molding for production is provided with a curable plastics material within a mold by infusion or injection, respectively. Where the resultant plastics moldings are to be subsequently coated after the curing of the curable plastics material, the component is subsequently cleaned, pretreated, and coated or varnished. An alternative possibility is that of in-mold coating, in which case right at the start the surface of the mold is initially provided with a coating system. While this coating system has already begun to cure, the plastics molding is subsequently produced on the system. After curing, usually thermal curing, both the resin and the coating system used have cured.

These methods are costly and inconvenient and lack great efficiency. There is a need for effective methods for coating plastics moldings, which can be integrated into the production operation already used, without the need to perform in-mold coating of the mold or downstream coating or varnishing of the plastics molding. Where possible the plastics molding is to be provided directly with a desired surface coating, without any need for the plastics moldings produced to undergo downstream movement, cleaning and coating, and without the molds needing to be cleaned.

EP 0 361 351 discloses a film which is coated on one side with a radiation-curable varnish and on the other side with an adhesive. The varnish is cured by irradiation and the film is heated and applied plastically to a three-dimensional article.

EP 0 819 520 discloses a method with which a film coating could be applied to three-dimensionally curved surfaces of dimensionally stable substrates. The film comprises one or more coating layers and an adhesive. Before application to the substrate, the coating without adhesive is part-cured. The ultimate curing takes place after application.

EP 0 950 492 discloses a coating material and a surface protection film which is able to endow a shaped article with abrasion resistance and chemical resistance, without forming cracks in the curved part of the shaped article.

EP 1 177 875 discloses a thermoformable film having a decorative color layer and having detachment properties, the film being introduced into a mold cavity corresponding to the ultimate product shape, and plastic is injected onto the rear of the film. The resulting molding is then parted from the film, with the color layer diffusing in the molding surface.

EP 1 304 235 discloses the production of a structured varnish layer by means of a carrier film. In this case, after the transfer of the structure, in an injection molding process, the intention is to peel off a carrier film having “release” quality.

EP 2 626 186 relates to a decorative resin film and to a shaped resin article and to a method for producing the shaped resin article, and more particularly to the production of an injection-molded article which is embossed by transfer from a decorative resin film.

US 2008/0302470 relates to a transfer sheet which is suitable for producing a transfer pattern on an article (for example, a deeply colored article) such as clothing, by generation of a recording image and transfer of the recorded image to the article, and to a method for producing a recorded image.

WO 95/16555 discloses an apparatus and a method for printing components made of polymer materials by thermoforming of a thermoplastic film, said film bearing an applied materials layer which carries a thermally diffusible dye. The heat of the thermoforming is used in order to cause the dye to diffuse from the carrier layer onto the thermoplastic film. In an alternative embodiment the invention utilizes the heat of the injection molding procedure in order to transfer sublimable dyes from a carrier layer, inserted into an injection mold, to the injection-molded component.

WO 00/13893 discloses a film coated with a plurality of layers. The surface of a polymeric film 10 to 500 μm thick is coated with at least one pigmented or unpigmented coating material layer and the coating material is optionally coated with a further thermoplastic film.

WO 2005/099943 discloses a flexible laminate composed of a substrate bearing an applied layer consisting of a curable varnish. The flexible laminar composite is nontacky when dried thermally. At least one removable protective layer, preferably a removable protective film, is preferably applied to the curable varnish layer.

WO 2013/160437 discloses the application of a protective layer system in the mold, said system comprising a polymeric film and a plasma-polymeric, silicon-organic layer. After a curing step, the plasma-polymeric, silicon-organic layer adheres more strongly to the polymeric film than to the plastics molding or the plastics intermediate.

WO 2014/083732 discloses in-mold shaping processes which employ a hard coating layer which has only very low stretchability.

WO 2014/124945 discloses silicone-coated release films with particular vacuum formability in the mold for producing plastics moldings to which a varnish is applied.

DE 4 425 342 discloses a method for producing a transfer film on a molding. The transfer film serves for the simultaneous provision of images during the forming operation, it being ensured that, following its transfer to the molding, the carrier film of the transfer film is able to detach uniformly from the image layer or design layer without thereby detracting from the shaping yield.

DE 101 40 769 relates to films coated at least with two coating layers, the carrier film bearing at least one coating layer which is curable by radiation and at least one second coating layer which is curable at least partly without radiation.

DE 10 2004 055363 discloses a flexible laminate comprising a carrier and, applied to the carrier, at least one layer of curable varnish. The layer of curable varnish preferably bears at least one applied, removable protective layer, preferably a removable protective film.

DE 10 2006 021646 discloses a film, more particularly a multilayer film, having at least one polypropylene film layer disposed on an outer side, where at least one polypropylene layer is mixed with at least one further material.

DE 10 2016 120781 discloses a composite film for the transfer of coating material, comprising a polymeric carrier film, a cured coating material, and a silicon-organic layer disposed between the carrier film and the coating material.

DE 10 2018 105523 relates to a method for producing a decorated molding, to a decorated molding, and to the use of a transfer film for producing a decorated molding.

The methods for transferring coating materials or varnishes to plastics moldings are not satisfactory in all respects, and there is a need for improvements.

### SUMMARY

It was an object of the invention to provide a method for coating plastics moldings with a coating material, possessing advantages over the methods of the prior art. The coating method ought to be able to be integrated reliably and with no downstream coating step into the manufacturing sequence of an industrial production process for plastics moldings. The coating ought more particularly to be able to be integrated into the known industrial production processes in such a way as not to necessitate any special safety measures. Moreover, the coating material prepared ought to be able to be stored for a long time before it is applied to the surface of the plastics moldings.

This object is achieved by the subjects of the claims.

It has surprisingly been found that it is possible to provide a carrier film which can be coated with a curable coating material, the coating material can be subsequently cured, optionally with heating, and the polymeric film with the coating material in the already cured state, produced in this way, can subsequently be formed at room temperature without the coating material detaching from the polymeric films.

It has surprisingly also been found that by means of the formed polymeric film, a plastics molding can be produced whose surface is formed by the coating material and whose surface nature is determined by the previously formed polymeric film (e.g., by its roughness, gloss, structure, embossing, etc.), by contacting a suitable curable plastics composition with the coating material and curing them to form the plastics molding.

It has surprisingly been found, furthermore, that on curing with the coating material, the curable plastics composition is able to develop a bond adhesion which is greater than the bond adhesion of the coating material on the carrier film. In this way a plastics molding is obtained which is covered on its surface with the formed polymeric film and hence protected. When the carrier film is removed, the coating material remains, owing to the greater bond adhesion than external coating, on the surface of the plastics component, and a coated plastics component is obtained whose coated surface can, as and when required, be further operated on or modified without additional cleaning or pretreatment steps.

Through a suitable choice of compatible materials for carrier film, coating material and curable plastics composition it is possible to ensure that the coating material in the as yet uncured state sufficiently wets the carrier film, and after curing adheres to it so well as to allow the polymeric film together with the coating material to be formed at room temperature, in light of the sufficient adhesion. If then, later on, during use of the polymeric film of the invention, the coating material is brought into contact with the curable plastics composition for the plastics molding, the plastics composition undergoes curing, with a resultant change in its properties.

If coating material and curable plastics composition are based on compatible materials, the curing of the plastics composition is accompanied by the development of a relatively strong bond between coating material and the surface of the plastics molding, and the bond adhesion is particularly strong as a result. This may be attributable to the formation of relatively strong covalent bonds and/or to a relatively large number of covalent bonds per unit area. This explains why, when the carrier film is removed from the plastics molding, the lowest bond adhesion in the laminate is exhibited no longer by the contact face between plastics molding and coating material but instead by the contact face between coating material and carrier film, and so it is here that delamination takes place. In accordance with the invention, however, it is not absolutely necessary for covalent bonds to be formed in order to achieve this effect; instead, it may be enough for physical interactions differing in strength to exist and/or for noncovalent bonds to be formed.

A first aspect of the invention relates to a polymeric film for coating plastics moldings with the coating material, where the polymeric film is formable at room temperature and comprises an adhesion-modified layer and a layer of the coating material;

where the coating material wholly or partly covers the adhesion-modified layer;
where the adhesion-modified layer has a layer thickness of at least 1.0 μm, is in direct contact with the coating material, and
(i) has a surface energy, on its surface side facing the coating material, of at least 27 mN/m; and/or
(ii) is based on a mixture which comprises at least one polyolefin and at least (a) one adhesion promoter, (b) one thermoplastic elastomer or (c) one polyamide alloy.

Unless otherwise defined, all of the standards indicated in the description are valid in the version valid most recently on the filing date of the patent application.

The coating material and the curable plastics composition are preferably both each curable, meaning that both occur initially in a curable state and subsequently in a cured state. In the production of the polymeric film of the invention, the curable coating material (a reactive varnish, for example) is first contacted with the adhesion-modified layer, with the wetting being sufficient for adhesion. The coating material then cures on the adhesion-modified layer, possibly with development of covalent bonds or noncovalent physical interactions at the contact face between the cured coating material and the adhesion-modified layer. In the subsequent use of the polymeric film of the invention thus produced, after the forming operation, the cured coating material is contacted first with the curable plastics composition, on the side of the coating material that faces away from the adhesion-modified layer. In this procedure, the curable plastics composition wets the cured coating material. The plastics composition subsequently cures, with development of covalent bonds or noncovalent physical interactions at the contact face between the cured coating material and the cured plastics composition. Owing to the nature/number of these covalent bonds or noncovalent physical interactions, the adhesion of the cured coating material to the cured plastics composition is stronger than the adhesion of the cured coating material to the adhesion-modified layer.

The polymeric film of the invention is suitable for the coating of plastics moldings with a coating material.

Plastics moldings contemplated in this context include, for example, fiber composite materials, for which fibers are impregnated with curable resins, examples being epoxy resins, acrylate resins, urethane resins, phenol-novolac resins and unsaturated polyester resins. These resins are frequently provided from one or two components. The resins cure spontaneously at room temperature or require separate activation for curing, frequently by heat, radiation or moisture. Plastics moldings particularly preferred in the invention are produced as foams, with polyurethane foams being particularly preferred.

The coating, in the invention, of the plastics molding with the coating material, using the polymeric film of the invention, is typically accomplished by first forming the polymeric film, preferably at room temperature or at elevated temperature of preferably not more than 90° C., more preferably in the range from 70 to 80° C., with the formed polymeric film in this way acquiring a three-dimensional configuration. The forming process here takes place preferably such that the coating material faces the interior of the formed configuration.

The degree of forming is in principle not limited in the invention, but is dependent on the particular nature of the individual layers of the polymeric film, including in particular the coating material. Preferred forming ratios may be situated, for example, in the range from 2% to 400%, preferably 5% to 300%, or 5% to 50%.

In this case the polymeric film of the invention is preferably placed onto a suitable mold of suitable shape, for example applied thereto with the aid of a suitable tensioning tool, and given an airtight seal with the mold at the edge, to form a closed cavity formed on one side by the polymeric film and on the other side by the mold. The coating material of the polymeric film is initially facing away from this cavity. By application of a vacuum in the cavity, the polymeric film can then be formed, and subsequently conforms to the internal surface of the mold. As a result the coating material is now facing the interior of the formed configuration. The polymeric film of the invention is preferably applied to the mold at room temperature and also formed at room temperature. Since, however, the mold has usually been heated, to an increased temperature, for example, of preferably not more than 90° C., more preferably in the range from 70 to 80° C., the polymeric film of the invention as well is heated to a certain degree during the forming operation, particularly when it comes, at the end of the forming operation, into contact with the surface of the heated mold.

Subsequently, by means of the mold, the coating material is transferred to the plastics molding under production, at least in a section of its outer surface. The mold is used here for shaping the plastics molding, with the shaping of the mold determining the shaping of the plastics molding. In this case, moreover, the coating material is transferred onto the molding, with the surface nature of the coating material being determined by the previously formed polymeric film (e.g., by its roughness, gloss, structure, embossing, etc.).

In addition the formed polymeric film also has a coating effect, since the coating material initially present on the carrier layer (adhesion-modified layer) of polymeric film is transferred to the surface of the plastics molding in situ. A particular advantage here is that all of the other constituents of the polymeric film (adhesion-modified layer and all other layers where present) can initially remain on the surface of the plastics molding and so protect its coated surface. Either immediately after the production of the plastics molding or else at a later point in time, these other constituents of the polymeric film may then be removed in one operation, without residue, from the surface of the plastics molding, thereby exposing its coated surface.

The residue-free removal of the completed plastics molding from the mold is possible in accordance with the invention preferably by virtue of the fact that the adhesion between the outer side of the polymeric film, facing away from the plastics molding, and the mold surface is lower than the adhesion between the carrier layer (adhesion-modified layer) and the coating material and also than the adhesion between the coating material and the cured plastics composition of the plastics molding. In the invention, therefore, it is possible preferably to forgo the use of mold release agents, etc., and cleaning of the mold surface is preferably not needed as well.

The polymeric film of the invention is formable at room temperature. The polymeric film of the invention need not necessarily be formed at room temperature. Instead in the invention it is also possible for the polymeric film to be formed at elevated temperature, but preferably at not more than 90° C. Many conventional polymeric films are not formable at room temperature (23° C.), instead requiring heating to elevated temperature, because the polymers on which these conventional polymeric films are based have relatively high softening temperatures. The polymeric film of the invention, however, is formable at 23° C., this formability being preferably defined such that the elongation at break of the polymeric film at 23° C. is at least 25% or at least 50%, more preferably at least 75% or at least 100%, more preferably still at least 150% or at least 200%, very preferably at least 250%, most preferably at least 300%, and more particularly at least 350%. The elongation at break at 23° C. is determined here in the invention preferably according to EN ISO 527. In this context the force at elongations of up to 350% is preferably at most 30 N/15 mm, more preferably at most 25 N/15 mm, more preferably still at most 20 N/15 mm.

The polymeric film of the invention is formable as such at room temperature, meaning that all of its constituents have this quality. As well as the carrier layer (adhesion-modified layer), therefore, all other constituents of the polymeric film are formable at room temperature as well, including in particular the coating material. As well as the aforementioned elongation at break, formability at room temperature means that the coating material remains adhering to the carrier layer (adhesion-modified layer) during the forming operation, and hence does not detach prematurely.

The polymeric film of the invention comprises an adhesion-modified layer and also a layer of the coated material. Accordingly the polymeric film of the invention comprises at least 2 layers (monofilm), where the layer of the coating material need possibly not be a full-area layer. Besides the adhesion-modified layer and the layer of the coating material, the polymeric film of the invention may comprise one or more additional layers. In preferred embodiments the polymeric film of the invention consists of a total of 2, 3, 4, 5 or 6 layers.

In one preferred embodiment the polymeric film of the invention comprises a layer of coating material, an adhesion-modified layer, and a further layer, which preferably forms the other outer side of the polymeric film (preferred layer sequence: coating material//adhesion-modified layer//further layer). In this case there may possibly be one or more additional layers present between the adhesion-modified layer and the further layer and/or on the outer side of the further layer. In one preferred embodiment the polymeric film of the invention consists of the layer of coating material, the adhesion-modified layer, and the further layer.

In another preferred embodiment the polymeric film of the invention consists of a layer of coating material, an adhesion-modified layer, a core layer and a further layer which preferably forms the other outer side of the polymeric film (preferred layer sequence: coating material//adhesion-modified layer//core layer//further layer). In this case there may possibly be one or more additional layers present between the adhesion-modified layer and the core layer and/or between the core layer and the further layer and/or on the outer side of the further layer. In one preferred embodiment the polymeric film of the invention consists of the layer of coating material, the adhesion-modified layer, the core layer, and the further layer.

The coating material wholly or partly covers the adhesion-modified layer, and the coating material in this case may in turn be single-layer or multilayer. The coating material covers preferably at least 20% of the area of the adhesion-modified layer, more preferably at least 40%, more preferably still at least 60%, very preferably at least 80%, most preferably at least 90%, and more particularly at least 95%. A partial coverage has the effect that the plastics molding coated or produced with the polymeric film of the invention is also coated only on part of its surface with the coating material, with the percentage degree of the coverage usually changing as a result of the forming operation. With preference the coating material wholly covers the adhesion-modified layer.

The adhesion-modified layer of the polymeric film of the invention has a layer thickness of at least 1.0 μm, preferably at least 2.5 μm, more preferably at least 5.0 μm, more preferably still at least 7.5 μm, very preferably at least 10 μm, most preferably at least 12.5 μm, and more particularly at least 15 μm.

The adhesion-modified layer of the polymeric film of the invention has a layer thickness of at most 50 μm, preferably at most 45 μm, more preferably at most 40 μm, more preferably still at most 35 μm, very preferably at most 30 μm, most preferably at most 25 μm, and more particularly at most 20 μm.

Suitable techniques for determining the total layer thickness of films and also the layer thickness of individual layers are known to a skilled person. The determination is preferably made by microscope on a microtome section, as a mean formed over ten measuring points.

The adhesion-modified layer of the polymeric film of the invention is in direct contact with the coating material.

In one preferred embodiment (i) the adhesion-modified layer, on its surface side facing the coating material, has a surface energy of at least 27 mN/m, preferably at least 27.5 mN/m, more preferably at least 28 mN/m, more preferably still at least 28.5 mN/m, very preferably at least 29 mN/m, most preferably at least 29.5 mN/m, and more particularly at least 30 mN/m.

In one preferred embodiment (i) the adhesion-modified layer, on its surface side facing the coating material, has a surface energy of at most 38 mN/m, preferably at most 37 mN/m, more preferably at most 36 mN/m, more preferably still at most 35 mN/m, very preferably at most 34 mN/m, most preferably at most 33 mN/m, and more particularly at most 32 mN/m.

Suitable techniques for determining the surface energy (surface tension, specific surface energy) of the polymer compositions are known to a skilled person. The determination is made preferably according to DIN 55660-2:2011-12.

In one preferred embodiment (ii) the adhesion-modified layer is based on a mixture which comprises at least one polyolefin (preferably an ethylene-propylene copolymer) and at least (a) an adhesion promoter (preferably an acid anhydride-modified polyolefin), (b) a thermoplastic elastomer or (c) a polyamide alloy.

The two embodiments (i) and (ii) stated above may be realized alternatively or both simultaneously; i.e., embodiment (i) may be realized, but embodiment (ii) not; or embodiment (ii) may be realized, but embodiment (i) not; or both embodiment (i) and embodiment (ii) may both be realized simultaneously.

The polymeric film of the invention is preferably thermally robust. Although the polymeric film of the invention is formed preferably at room temperature (or at only moderately elevated temperature), it preferably has a sufficient temperature stability, allowing the coating material to be dried and/or cured following application to the adhesion-modified layer. Depending on the chemical composition and nature of the composition used for producing the layer of the coating material, it may for this purpose be appropriate, for example, to evaporate solvent residues and/or to induce chemical crosslinking reactions. For that purpose it may be preferable to heat the polymeric film of the invention prior to forming, preferably to a temperature of not more than 120° C., more preferably not more than 110° C., more preferably still not more than 100° C. In all layers of the polymeric film of the invention, therefore, the polymers or polymer mixtures preferably have in each case a melting temperature of at least 110° C., preferably determined by DSC according to DIN EN ISO 11357-3:2018-07, on the basis of the main signal in the case of multiple DSC signals (in the case, for example, of heterophasic ethylene-propylene copolymers).

The polymeric film of the invention is preferably not drawn, i.e., not oriented, neither monoaxially nor biaxially.

The polymeric film of the invention preferably has a total layer thickness of at least 40 μm, more preferably at least 50 μm, more preferably still at least 60 μm, very preferably at least 70 μm, most preferably at least 80 μm, and more particularly at least 90 μm. Where the coating material only partly covers the adhesion-modified layer, the total layer thickness is determined at points at which the adhesion-modified layer is covered with coating material. If the coating material has initially been processed with the aid of a solvent, the layer thickness in the invention is measured in the dried state.

The polymeric film of the invention preferably has a total layer thickness of at most 250 μm, more preferably at most 200 μm, more preferably still at most 180 μm, very preferably at most 160 μm, most preferably at most 140 μm, and more particularly at most 120 μm. Where the coating material only partly covers the adhesion-modified layer, the total layer thickness is determined at points at which the adhesion-modified layer is covered with coating material.

In one preferred embodiment the polymeric film of the invention is embossed at least on one side, and preferably has double-sided embossing. This may be of advantage if the surface of the plastics molding to be produced is to be structured. The embossing of the polymeric film in that case extends to the coating material and is then transferred to the surface of the plastics molding.

The coating material of the polymeric film of the invention must have certain properties, and more particularly must be compatible with the material of the adhesion-modified layer and with the material of the plastics molding whose surface is to be coated. For transfer of the coating material from the polymeric film to the plastics molding it is essential that the coating material develops a bond adhesion, to the material of the plastics molding, and is greater than the bond adhesion of the coating material to the adhesion-modified layer. Otherwise, later on, on removal of the polymeric film (adhesion-modified layer and also any further layers present), the coating material, rather than remaining on the surface of the plastics molding, would be removed together with the polymeric film.

Materials with suitable compatibility can be ascertained by a skilled person as part of customary routine tests. In this case it is of advantage in principle if the chemical nature of the coating material is at least similar to the chemical nature of the material from which the plastics molding is to be produced. For example, if the plastics molding is to be produced from a polyurethane foam, it is of advantage if the coating material as well is based on polyurethane, or at least contains functional groups which are able to form covalent bonds with the reactive components of polyurethane foams (e.g. —OH, —NHR, —NH₂, —C(═O)OH, —C(═O)OC(═O)R, etc.). The compatibility here is determined not only by the chemical nature of the functional groups and of the covalent bonds possibly arising through reaction, and/or of the physical interactions generated by noncovalent bonds, but also, in particular, by the number of functional groups available. These parameters must be balanced with the corresponding interactions between the coating material and the adhesion-modified layer.

Customarily it will be of advantage if the coating material enters into more and/or stronger covalent and/or noncovalent interactions with the material of the plastics molding than the coating material with the adhesion-modified layer. Possible indicators, for the purpose of estimating the respective interactions, include not only chemical considerations but also the surface energies of the materials involved. Account should also be taken of the specific reaction conditions under which the plastics molding is produced (pressure, temperature).

The coating material has preferably been produced from a curable composition, i.e., from a composition which reacts chemically with curing, customarily with crosslinking. The coating material is preferably present in such a state, having already undergone curing, i.e., crosslinking, on the adhesion-modified layer. As already mentioned above, the curing may optionally take place at elevated temperature, in which case it is important that the polymeric film withstands these conditions, and this may be ensured by selection, among other factors, of suitable polymers having suitable melting temperatures. As likewise already mentioned above, however, the coating material in such a cured state must also be formable at room temperature, i.e., must have sufficient elongation at break and also adhesion to the adhesion-modified layer.

In one particularly preferred embodiment the coating material is a varnish. The varnish in this case may be a thermosetting varnish or a UV curing varnish. In one preferred embodiment the varnish is thermosetting. In another preferred embodiment the varnish is UV curing. The varnish is based preferably on epoxide, polyurethane or polyacrylate. The varnish is preferably compatible with the curable plastics composition from which the plastics molding to be coated is produced. Varnish and curable plastics composition are preferably both based on polymers of the same type. Formable varnishes are known to a skilled person and available commercially (for example, from Proell, Weißenburg, DE; from Lott-Lacke, Herford, DE; or from Hesse Lignal, Hamm, DE).

In one preferred embodiment the coating material, the varnish for example, is based on epoxide, preferably on thermosetting epoxide, and the curable plastics composition is likewise based on epoxide, preferably on thermosetting epoxide.

In another preferred embodiment the coating material, the varnish for example, is based on polyurethane, preferably on thermosetting polyurethane, and the curable plastics composition is likewise based on polyurethane, preferably on thermosetting polyurethane.

In another preferred embodiment the coating material, the varnish for example, is based on polyacrylate, preferably on thermosetting polyacrylate, and the curable plastics composition is likewise based on polyacrylate, preferably on thermosetting polyacrylate.

The coating material may be colorless or may have been colored. Colored coating materials, colored varnishes for example, are available commercially. In one preferred embodiment the coating material wholly or partly covers the adhesion-modified layer, with the covered regions of the adhesion-modified layer being covered locally over the area of the adhesion-modified layer with different coating materials, such as with different-colored varnishes, for example. The adhesion-modified layer may for example be covered, wholly or partly, as coating material, with a printed image made up of different colors.

In the invention it is preferable for the coating material, optionally after the curing and/or drying, still to have free functional groups which are capable of entering into covalent bonds or noncovalent physical interactions with free functional groups of the curable plastics composition.

Where, for example, the curable plastics composition contains free epoxy groups, which are intended for reaction with other suitable functional groups of the plastics composition for the purpose of curing the plastics composition (e.g., —OH, —NH₂, —NHR, —CO₂H, etc.), it is preferred in the invention for the coating material as well, optionally after the curing and/or drying, still to have such free functional groups (e.g. —OH, —NH₂, —NHR, —CO₂H, etc.).

Where, for example, the curable plastics composition contains free isocyanate groups, which are intended for reaction with other suitable functional groups of the plastics composition for the purpose of curing the plastics composition (e.g., —OH, —NH₂, —NHR, etc.), it is preferred in the invention for the coating material as well, optionally after the curing and/or drying, still to have such free functional groups (e.g. —OH, —NH₂, —NHR, etc.).

A skilled person is fundamentally aware of which materials are compatible with one another in this sense, in other words of which free functional groups are suitable, optionally, for reacting with free functional groups of the coating material when the plastics composition is cured, and in this way of forming covalent bonds at the contact area of coating material and plastics composition. A skilled person is also fundamentally aware of which materials are compatible with one another in this sense, i.e., of which materials are suitable, optionally, for developing effective adhesion, by noncovalent interactions, to the contact area of coating material and plastics composition when the plastics composition is cured with the coating material.

The coating material, the varnish for example, may comprise customary additives, more particularly fillers, pigments and also, optionally, solvents, in each case in customary amounts.

Suitable coating materials, varnishes for example, are known to a skilled person and available commercially. Coating materials particularly preferred in the invention, varnishes for example, are aqueous epoxides, solvent borne epoxides, dry epoxides, aqueous polyurethanes, solvent borne polyurethanes, dry polyurethanes, aqueous polyacrylates, solvent borne polyacrylates or dry polyacrylates, which are in each case available commercially.

The coating material preferably forms one of the two outer sides of the polymeric film, allowing the coating material to be brought into direct contact with the material used for producing the plastics molding.

The coating material (preferably in the cured, dry state) preferably has a layer thickness of at least 5 μm, more preferably at least 10 μm, more preferably still at least 15 μm, very preferably at least 20 μm, most preferably at least 25 μm, and more particularly at least 30 μm.

The coating material (preferably in the cured, dry state) preferably has a layer thickness of at most 100 μm, more preferably at most 90 μm, more preferably still at most 80 μm, very preferably at most 70 μm, most preferably at most 60 μm, and more particularly at most 50 μm.

The layer thickness of the coating material accounts preferably for less than 50% of the total layer thickness of the polymeric film of the invention, more preferably at most 48%, more preferably still at most 46%, most preferably at most 44%, and more particularly at most 42%.

The surface side of the polymeric film (carrier film, adhesion-modified layer) that faces the coating material has preferably not been surface-activated, by corona, plasma or other customary techniques for activating plastics surfaces, for example. In the invention such surface treatment is omitted so that the bond adhesion of the surface material to the polymeric film (carrier film, adhesion-modified layer) is on the one hand sufficient to withstand the conditions of forming but on the other hand is also not too great, so as to allow the transfer of the coating material from the polymeric film (carrier film, adhesion-modified layer) to the surface of the plastics molding. In the invention this bond adhesion is established not by surface activation, but instead by the chemical composition of coating material on the one hand and polymeric film (carrier film, adhesion-modified layer) on the other.

So that the bond adhesion of the coating material to the adhesion-modified layer is not too great, it may be preferable in the invention for the adhesion-modified layer to have a surface energy, on its surface side facing the coating material, of at most 42 mN/m, more preferably at most 40 mN/m, more preferably still at most 38 mN/m, very preferably at most 36 mN/m, most preferably at most 34 mN/m, and more particularly at most 32 mN/m.

In particularly preferred embodiments of the polymeric film of the invention, the adhesion-modified layer is based on a mixture which comprises at least one polyolefin and at least one adhesion promoter, where the adhesion promoter is selected from:
acid anhydride-modified polyolefins; preferably graft copolymers, e.g., polyolefins copolymerized with unsaturated acid anhydrides (e.g., maleic anhydride-grafted polypropylene, PP-g-MAH, or maleic anhydride-grafted styrene-ethylene/butylene-styrene, SEBS-g-MAH [e.g. Tuftec®]);
hydroxyl-modified polyolefins; preferably polyolefins copolymerized with vinyl acetate which have been subsequently fully or partly hydrolyzed, or polyolefins copolymerized with hydroxyethyl acrylate;
acid-modified polyolefins or acetate-modified polyolefins; preferably polyolefins (e.g. polyethylenes) copolymerized with vinyl acetate and/or butyl acetate, such as, for example, ethylene-vinyl acetate copolymers or ethylene-butyl acetate copolymers; and
epoxy-modified polyolefins; preferably polyolefins modified with glycidyl methacrylate.

The adhesion promoters identified above have in common the fact that they are copolyolefins, preferably ethylene copolymers or propylene copolymers, which have been obtained by copolymerization with suitable comonomers containing functional groups. The amount of comonomers with such functional groups, based on the entirety of all the monomers contained in copolymers, may vary in the invention and is preferably at least 0.1 mol %, more preferably at least 0.5 mol %, more preferably still at least 1.0 mol %, very preferably at least 2.5 mol %, most preferably at least 5.0 mol %, and more particularly at least 7.5 mol %.

Suitable adhesion promoters are known to a skilled person and are available commercially. Adhesion promoters particularly preferred in the invention are polymers of the Admer® series from Mitsui Chemicals.

The weight fraction of the adhesion promoter is preferably in the range from 10 wt % to 65 wt %, preferably 20 wt % to 30 wt %, based on the total weight of the adhesion-modified layer.

In particularly preferred embodiments of the polymeric film of the invention the adhesion-modified layer is based on a mixture which comprises at least one polyolefin and at least one adhesion promoter, the at least one polyolefin being selected from the group consisting of polyethylene homopolymer, polyethylene copolymer, polypropylene homopolymer and polypropylene copolymer; preferably heterophasic ethylene-propylene copolymer (HeCo PP). Particularly preferred heterophasic ethylene-propylene copolymers are rTPOs (reactor-made thermoplastic olefins).

Suitable polyolefins are known to a skilled person and are available commercially. Polyolefins particularly preferred in the invention are polyolefins of the Adflex® series from LyondellBasell.

The weight fraction of the mixture is preferably at least 70 wt %, more preferably at least 75 wt %, more preferably still at least 80 wt %, very preferably at least 85 wt %, most preferably at least 90 wt %, and more particularly at least 95 wt %, based in each case on the total weight of the adhesion-modified layer. The remaining weight fraction may be accounted for optionally by customary additives, such as, for example, stabilizers, antioxidants, antistats, plasticizers, pigments, fillers, processing aids, etc.

Particularly preferred embodiments H¹ to H¹⁶ of the adhesion-modified layer are collated in the table below; in each case there may additionally be customary additives present in customary amounts:

| | H¹ | H² | H³ | H⁴ | H⁵ | H⁶ | H⁷ | H⁸ |
|---|---|---|---|---|---|---|---|---|
| Layer thickness [μm]: | 17 ± 15 | 17 ± 15 | 17 ± 15 | 17 ± 10 | 17 ± 10 | 17 ± 10 | 17 ± 5 | 17 ± 5 |
| Ethylene-propylene copolymer | 66 ± 20 | 66 ± 18 | 66 ± 16 | 66 ± 14 | 66 ± 12 | 66 ± 10 | 66 ± 8 | 66 ± 6 |
| [wt %] | | | | | | | | |
| Adhesion promoter [wt %] | 27 ± 20 | 27 ± 18 | 27 ± 16 | 27 ± 14 | 27 ± 12 | 27 ± 10 | 27 ± 8 | 27 ± 6 |
| | H⁹ | H¹⁰ | H¹¹ | H¹² | H¹³ | H¹⁴ | H¹⁵ | H¹⁶ |
| Layer thickness [μm]: | 17 ± 15 | 17 ± 15 | 17 ± 15 | 17 ± 10 | 17 ± 10 | 17 ± 10 | 17 ± 5 | 17 ± 5 |
| rTPO [wt %] | 66 ± 20 | 66 ± 18 | 66 ± 16 | 66 ± 14 | 66 ± 12 | 66 ± 10 | 66 ± 8 | 66 ± 6 |
| PP-g-MAH [wt %] | 27 ± 20 | 27 ± 18 | 27 ± 16 | 27 ± 14 | 27 ± 12 | 27 ± 10 | 27 ± 8 | 27 ± 6 |

Adhesion-modified layers of this kind based on a mixture comprising at least one polyolefin and at least one adhesion promoter have the advantage that the components of the mixture have comparatively good compatibility, with consequences possibly including a favorable effect on the nature of the surface produced. This advantage is balanced, however, by the fact that the release forces between the adhesion-modified layer and the (cured) coating material can be varied only within somewhat narrower limits than is the case when using thermoplastic elastomers (TPEs) or polyamide alloys.

In the invention, when using adhesion-modified layers of this kind, based on a mixture comprising at least one polyolefin and at least one adhesion promoter, the release force between the adhesion-modified layer and the (cured) coating material, a polyurethane varnish for example, is in the range from 1.0 to 10 cN/cm, more preferably 1.5 to 6.0 cN/cm. The respective release force value may be adjusted via the relative weight fraction of the adhesion promoter.

In the invention, for determining the release force, sample strips are produced. This is done by knife-coat application of the curable coating material (e.g., a 2-component polyurethane varnish) to a sheet in DIN A4 format of the polymeric film, in an amount such that the layer thickness of the varnish after drying in a forced air oven is 40 μm. After the polyurethane varnish (coating material) has cured or dried, a determination is made of the release force between the adhesion-modified layer and the coating material. The release force is determined in a method based on the Finat test method (without storage) on strips with a width of 40 mm of the sheet in DIN A4 format, by means of a model Z0.5 tensile testing machine from Zwick/Roell. Measurement takes place on sets of three strips. The strips are adhered by the varnish side to a metal support plate furnished with a double-sided adhesive tape (CMC 10730). The metal support plate is introduced into the bottom clamping jaw of the test apparatus, and the film is parted from varnish at a lower edge and adhered to a stiff film strip, which is introduced into the upper clamping jaw. The measurement takes place at 300 mm/min.

In further particularly preferred embodiments of the polymeric film of the invention the adhesion-modified layer is based on a mixture which comprises at least one polyolefin and at least one thermoplastic elastomer (TPE), optionally in combination with one or more “compatibilizers” for improving the compatibility of the polyolefin with the thermoplastic elastomer. Here the at least one polyolefin is selected from the group consisting of polyethylene homopolymer, polyethylene copolymer, polypropylene homopolymer and polypropylene copolymer; preferably heterophasic ethylene-propylene copolymer (HeCo PP). Particularly preferred heterophasic ethylene-propylene copolymers are rTPOs (reactor-made thermoplastic olefins). The at least one thermoplastic elastomer is preferably selected from the thermoplastic copolyester elastomers (TPE-E), thermoplastic polyamide elastomers (TPA) and thermoplastic polyurethane elastomers (TPU), preferably TPE-E. Suitable thermoplastic elastomers are known to the skilled person and are available commercially (e.g., the Hytrel® series from DuPont).

The weight fraction of the thermoplastic elastomer is preferably in the range from 1.0 wt % to 35 wt %, preferably 5.0 wt % to 15 wt %, based on the total weight of the adhesion-modified layer.

When using thermoplastic copolyester elastomers (TPE-E), compatibilizers used are preferably ethylene-acrylate copolymers or the above-described adhesion promoters, preferably MAH grafted ethylene-acrylate copolymers and/or ethylene-acrylate-glycidyl methacrylate terpolymers.

The weight fraction of the compatibilizer is preferably in the range from 1.0 wt % to 25 wt %, preferably 2.5 wt % to 15 wt %, based on the total weight of the adhesion-modified layer.

Adhesion-modified layers of this kind, based on a mixture comprising at least one polyolefin and at least one thermoplastic elastomer (TPE), optionally in combination with one or more compatibilizers, have the advantage that the release forces between the adhesion-modified layer and the (cured) coating material can be varied within wide limits. This advantage is balanced, however, by the fact that the compatibility of the components of the mixture with one another is somewhat poorer.

In the invention, when using adhesion-modified layers of this kind, based on a mixture comprising at least one thermoplastic elastomer (TPE), optionally in combination with one or more compatibilizers, the release force between the adhesion-modified layer and the (cured) coating material, a polyurethane varnish for example, is in the range from 1.0 to 50 cN/cm, more preferably 2.5 to 45 cN/cm. The respective release force value may be adjusted via the relative weight fraction of the thermoplastic elastomer (TPE) and optionally of the compatibilizer. When the weight fraction of the thermoplastic elastomer (TPE) is comparatively small, it is possible to omit compatibilizers; with increasing weight fraction of the thermoplastic elastomer (TPE), the addition of the compatibilizer is preferred.

In further particularly preferred embodiments of the polymeric film of the invention the adhesion-modified layer is based on a mixture which comprises at least one polyolefin and at least one polyamide alloy. Here the at least one polyolefin is selected from the group consisting of polyethylene homopolymer, polyethylene copolymer, polypropylene homopolymer and polypropylene copolymer; preferably heterophasic ethylene-propylene copolymer (HeCo PP). Particularly preferred heterophasic ethylene-propylene copolymers are rTPOs (reactor-made thermoplastic olefins). The at least one polyamide alloy is preferably a polyamide-based thermoplastic alloy. For the purpose of description, polymer alloys are materials comprising two or more at least partly miscible polymers or materials composed of multiphase copolymers. Polymer alloys have uniform physical properties throughout their volume. In comparison with this, the polymers in polymer blends are exclusively physically mixed and need not be miscible. Preferred polyamide alloys are those of the Orgalloy® series, especially flexible Orgalloy® LT grades. Suitable polyamide alloys are known to a skilled person and are available commercially (e.g., the Orgalloy® series from Arkema).

The weight fraction of the polyamide alloy is preferably in the range from 10 wt % to 60 wt %, preferably 25 wt % to 50 wt %, based on the total weight of the adhesion-modified layer.

Adhesion-modified layers of this kind, based on a mixture comprising at least one polyolefin and at least one polyamide alloy, have the advantage that the release forces between the adhesion-modified layer and the (cured) coating material can be varied within wide limits. This advantage is balanced, however, by the fact that the compatibility of the components of the mixture with one another is somewhat poorer.

In the invention, when using adhesion-modified layers of this kind, based on a mixture comprising at least one polyamide alloy, the release force between the adhesion-modified layer and the (cured) coating material, a polyurethane varnish for example, is in the range from 1.0 to 25 cN/cm, more preferably 2.0 to 10 cN/cm. The respective release force value may be adjusted via the relative weight fraction of the polyamide alloy.

In one preferred embodiment the polymeric film of the invention preferably comprises a further layer as well as the adhesion-modified layer and the layer of the coating material.

The further layer is preferably disposed on that surface side of the adhesion-modified layer that faces away from the coating material.

The further layer preferably forms one of the two outer sides of the polymeric film. The polymeric film of the invention preferably consists of the layer of the coating material (first outer layer), the adhesion-modified layer (carrier layer), and the further layer (second outer layer).

The further layer, on its surface side facing away from the adhesion-modified layer, is preferably not furnished with release properties, instead preferably only having no adhesion promoter in the mixture with the other polymers which form the further layer. As and when required, however, it is possible in principle in the invention to furnish the further layer, on its surface side facing away from the adhesion-modified layer, with release properties, by coating it with silicones, for example.

The further layer is preferably based on a polyolefin or on a mixture of different polyolefins, preferably each selected independently of one another from the group consisting of polyethylene homopolymer, polyethylene copolymer, polypropylene homopolymer and polypropylene copolymer; preferably heterophasic ethylene-propylene copolymer (HeCo PP). Particularly preferred heterophasic ethylene-propylene copolymers are rTPOs (reactor-made thermoplastic olefins). Suitable polyolefins are known to a skilled person and are available commercially. Polyolefins particularly preferred in the invention are polyolefins of the Adflex® series from LyondellBasell and polyolefins of the Inspire® series from Braskem.

In one preferred embodiment the adhesion-modified layer and the further layer are both based in each case on a mixture of an ethylene-propylene copolymer with a further polymer, said further polymer in the adhesion-modified layer being an adhesion promoter and said further polymer in the further layer being an ethylene-propylene copolymer which differs from the other ethylene-propylene copolymer in the further layer. The further layer in that case is based on a mixture of a 1^{st} ethylene-propylene copolymer and a 2^{nd} ethylene-propylene copolymer.

The further layer of the polymeric film of the invention preferably has a layer thickness of at least 1.0 μm, preferably at least 2.5 μm, more preferably at least 5.0 μm, more preferably still at least 7.5 μm, very preferably at least 10 μm, most preferably at least 12.5 μm, and more particularly at least 15 μm.

The further layer of the polymeric film of the invention preferably has a layer thickness of at most 50 μm auf, preferably at most 45 μm, more preferably at most 40 μm, more preferably still at most 35 μm, very preferably at most 30 μm, most preferably at most 25 μm, and more particularly at most 20 μm.

By virtue of this configuration it is possible for the polymeric film of the invention to be wound into rolls against itself for storage, and stored and transported in this form.

Particularly preferred embodiments W¹ to W¹⁶ of the further layer are collated in the table below; in each case there may additionally be customary additives present in customary amounts:

| | W¹ | W² | W³ | W⁴ | W⁵ | W⁶ | W⁷ | W⁸ |
|---|---|---|---|---|---|---|---|---|
| Layer thickness [μm]: | 17 ± 15 | 17 ± 15 | 17 ± 15 | 17 ± 10 | 17 ± 10 | 17 ± 10 | 17 ± 5 | 17 ± 5 |
| 1^{st} ethylene-propylene | 66 ± 20 | 66 ± 18 | 66 ± 16 | 66 ± 14 | 66 ± 12 | 66 ± 10 | 66 ± 8 | 66 ± 6 |
| copolymer [wt %] | | | | | | | | |
| 2^{nd} ethylene-propylene | 27 ± 20 | 27 ± 18 | 27 ± 16 | 27 ± 14 | 27 ± 12 | 27 ± 10 | 27 ± 8 | 27 ± 6 |
| copolymer [wt %] | | | | | | | | |
| | W⁹ | W¹⁰ | W¹¹ | W¹² | W¹³ | W¹⁴ | W¹⁵ | W¹⁶ |
| Layer thickness [μm]: | 17 ± 15 | 17 ± 15 | 17 ± 15 | 17 ± 10 | 17 ± 10 | 17 ± 10 | 17 ± 5 | 17 ± 5 |
| rTPO [wt %] | 66 ± 20 | 66 ± 18 | 66 ± 16 | 66 ± 14 | 66 ± 12 | 66 ± 10 | 66 ± 8 | 66 ± 6 |
| HeCo PP [wt %] | 27 ± 20 | 27 ± 18 | 27 ± 16 | 27 ± 14 | 27 ± 12 | 27 ± 10 | 27 ± 8 | 27 ± 6 |

In one preferred embodiment the polymeric film of the invention preferably comprises, as well as the adhesion-modified layer, the layer of the coating material and the further layer, a core layer, where the core layer is disposed preferably between the adhesion-modified layer and the further layer and/or where the further layer preferably forms one of the two outer sides of the polymeric film (preferred layer sequence: coating material//adhesion-modified layer//core layer//further layer).

The core layer is preferably based on a polyolefin or on a mixture of different polyolefins, preferably each selected independently of one another from the group consisting of polyethylene homopolymer, polyethylene copolymer, polypropylene homopolymer and polypropylene copolymer; preferably heterophasic ethylene-propylene copolymer (HeCo PP). Particularly preferred heterophasic ethylene-propylene copolymers are rTPOs (reactor-made thermoplastic olefins). Suitable polyolefins are known to a skilled person and are available commercially. Polyolefins particularly preferred in the invention are polyolefins of the Adflex® series from LyondellBasell and polyolefins of the Inspire® series from Braskem.

In one preferred embodiment both the core layer and the further layer are based on a mixture of two different ethylene-propylene copolymers in varying proportion (1^{st} ethylene-propylene copolymer in a mixture with 2^{nd} ethylene-propylene copolymer).

The core layer preferably has a lower layer thickness than the layer of coating material. The core layer preferably has a greater layer thickness than the adhesion-modified layer and/or a greater layer thickness than the further layer.

The core layer of the polymeric film of the invention preferably has a layer thickness of at least 4.0 μm, preferably at least 6.0 μm, more preferably at least 8.0 μm, more preferably still at least 10 μm, very preferably at least 15 μm, most preferably at least 20 μm, and more particularly at least 25 μm.

The core layer of the polymeric film of the invention preferably has a layer thickness of at most 60 μm, preferably at most 55 μm, more preferably at most 50 μm, more preferably still at most 45 μm, very preferably at most 40 μm, most preferably at most 35 μm, and more particularly at most 30 μm.

Particularly preferred embodiments K¹ to K¹⁶ of the core layer are collated in the table below; in each case there may additionally be customary additives present in customary amounts:

| | K¹ | K² | K³ | K⁴ | K⁵ | K⁶ | K⁷ | K⁸ |
|---|---|---|---|---|---|---|---|---|
| Layer thickness [μm]: | 26 ± 25 | 26 ± 25 | 26 ± 25 | 26 ± 20 | 26 ± 20 | 26 ± 20 | 26 ± 15 | 26 ± 15 |
| 1^{st} ethylene-propylene | 80 ± 18 | 80 ± 16 | 80 ± 14 | 80 ± 12 | 80 ± 10 | 80 ± 8 | 80 ± 6 | 80 ± 4 |
| copolymer [wt %] | | | | | | | | |
| 2^{nd} ethylene-propylene | 16 ± 14 | 16 ± 12 | 16 ± 10 | 16 ± 8 | 16 ± 6 | 16 ± 4 | 16 ± 2 | 16 ± 2 |
| copolymer [wt %] | | | | | | | | |
| | K⁹ | K¹⁰ | K¹¹ | K¹² | K¹³ | K¹⁴ | K¹⁵ | K¹⁶ |
| Layer thickness [μm]: | 26 ± 25 | 26 ± 25 | 26 ± 25 | 26 ± 20 | 26 ± 20 | 26 ± 20 | 26 ± 15 | 26 ± 15 |
| rTPO [wt %] | 80 ± 18 | 80 ± 16 | 80 ± 14 | 80 ± 12 | 80 ± 10 | 80 ± 8 | 80 ± 6 | 80 ± 4 |
| HeCo PP [wt %] | 16 ± 14 | 16 ± 12 | 16 ± 10 | 16 ± 8 | 16 ± 6 | 16 ± 4 | 16 ± 2 | 16 ± 2 |

Particularly preferred embodiments D¹ to D¹⁶ of the polymeric film of the invention with a total of at least three layers in the sequence layer of coating material//adhesion-modified layer//further layer are collated in the table below; in each case there may additionally be customary additives present in customary amounts

| | D¹ | D² | D³ | D⁴ | D⁵ | D⁶ | D⁷ | D⁸ |
|---|---|---|---|---|---|---|---|---|
| Coating material | | | | | | | | |
| Layer thickness [μm]: | 40 ± 30 | 40 ± 30 | 40 ± 20 | 40 ± 20 | 40 ± 15 | 40 ± 15 | 40 ± 10 | 40 ± 10 |
| Polyurethane varnish | 95 ± 5 | 95 ± 5 | 95 ± 5 | 95 ± 5 | 95 ± 5 | 95 ± 5 | 95 ± 5 | 95 ± 5 |
| [wt %] | | | | | | | | |
| Adhesion-modified layer | | | | | | | | |
| Layer thickness [μm]: | 17 ± 15 | 17 ± 15 | 17 ± 15 | 17 ± 10 | 17 ± 10 | 17 ± 10 | 17 ± 5 | 17 ± 5 |
| Ethylene-propylene | 66 ± 20 | 66 ± 18 | 66 ± 16 | 66 ± 14 | 66 ± 12 | 66 ± 10 | 66 ± 8 | 66 ± 6 |
| copolymer [wt %] | | | | | | | | |
| Adhesion promoter [wt %] | 27 ± 20 | 27 ± 18 | 27 ± 16 | 27 ± 14 | 27 ± 12 | 27 ± 10 | 27 ± 8 | 27 ± 6 |
| Further layer | | | | | | | | |
| Layer thickness [μm]: | 17 ± 15 | 17 ± 15 | 17 ± 15 | 17 ± 10 | 17 ± 10 | 17 ± 10 | 17 ± 5 | 17 ± 5 |
| 1^{st} ethylene-propylene | 66 ± 20 | 66 ± 18 | 66 ± 16 | 66 ± 14 | 66 ± 12 | 66 ± 10 | 66 ± 8 | 66 ± 6 |
| copolymer [wt %] | | | | | | | | |
| 2^{nd} ethylene-propylene | 27 ± 20 | 27 ± 18 | 27 ± 16 | 27 ± 14 | 27 ± 12 | 27 ± 10 | 27 ± 8 | 27 ± 6 |
| copolymer [wt %] | | | | | | | | |
| | D⁹ | D¹⁰ | D¹¹ | D¹² | D¹³ | D¹⁴ | D¹⁵ | D¹⁶ |
| Coating material | | | | | | | | |
| Layer thickness [μm]: | 40 ± 30 | 40 ± 30 | 40 ± 20 | 40 ± 20 | 40 ± 15 | 40 ± 15 | 40 ± 10 | 40 ± 10 |
| Polyurethane varnish | 95 ± 5 | 95 ± 5 | 95 ± 5 | 95 ± 5 | 95 ± 5 | 95 ± 5 | 95 ± 5 | 95 ± 5 |
| [wt %] | | | | | | | | |
| Adhesion-modified layer | | | | | | | | |
| Layer thickness [μm]: | 17 ± 15 | 17 ± 15 | 17 ± 15 | 17 ± 10 | 17 ± 10 | 17 ± 10 | 17 ± 5 | 17 ± 5 |
| rTPO [wt %] | 66 ± 20 | 66 ± 18 | 66 ± 16 | 66 ± 14 | 66 ± 12 | 66 ± 10 | 66 ± 8 | 66 ± 6 |
| Adhesion promoter | 27 ± 20 | 27 ± 18 | 27 ± 16 | 27 ± 14 | 27 ± 12 | 27 ± 10 | 27 ± 8 | 27 ± 6 |
| [wt %] | | | | | | | | |
| Further layer | | | | | | | | |
| Layer thickness [μm]: | 17 ± 15 | 17 ± 15 | 17 ± 15 | 17 ± 10 | 17 ± 10 | 17 ± 10 | 17 ± 5 | 17 ± 5 |
| rTPO [wt %] | 66 ± 20 | 66 ± 18 | 66 ± 16 | 66 ± 14 | 66 ± 12 | 66 ± 10 | 66 ± 8 | 66 ± 6 |
| HeCo PP [wt %] | 27 ± 20 | 27 ± 18 | 27 ± 16 | 27 ± 14 | 27 ± 12 | 27 ± 10 | 27 ± 8 | 27 ± 6 |

Particularly preferred embodiments V¹ to V¹⁶ of the polymeric film of the invention with a total of at least four layers in the sequence layer of coating material//adhesion-modified layer//core layer//further layer are collated in the table below; in each case there may additionally be customary additives present in customary amounts:

| | V¹ | V² | V³ | V⁴ | V⁵ | V⁶ | V⁷ | V⁸ |
|---|---|---|---|---|---|---|---|---|
| Coating material | | | | | | | | |
| Layer thickness [μm]: | 40 ± 30 | 40 ± 30 | 40 ± 20 | 40 ± 20 | 40 ± 15 | 40 ± 15 | 40 ± 10 | 40 ± 10 |
| Polyurethane varnish | 95 ± 5 | 95 ± 5 | 95 ± 5 | 95 ± 5 | 95 ± 5 | 95 ± 5 | 95 ± 5 | 95 ± 5 |
| [wt %] | | | | | | | | |
| Adhesion-modified layer | | | | | | | | |
| Layer thickness [μm]: | 17 ± 15 | 17 ± 15 | 17 ± 15 | 17 ± 10 | 17 ± 10 | 17 ± 10 | 17 ± 5 | 17 ± 5 |
| Ethylene-propylene | 66 ± 20 | 66 ± 18 | 66 ± 16 | 66 ± 14 | 66 ± 12 | 66 ± 10 | 66 ± 8 | 66 ± 6 |
| copolymer [wt %] | | | | | | | | |
| Adhesion promoter [wt %] | 27 ± 20 | 27 ± 18 | 27 ± 16 | 27 ± 14 | 27 ± 12 | 27 ± 10 | 27 ± 8 | 27 ± 6 |
| Core layer | | | | | | | | |
| Layer thickness [μm]: | 26 ± 25 | 26 ± 25 | 26 ± 25 | 26 ± 20 | 26 ± 20 | 26 ± 20 | 26 ± 15 | 26 ± 15 |
| 1^{st} ethylene-propylene | 80 ± 18 | 80 ± 16 | 80 ± 14 | 80 ± 12 | 80 ± 10 | 80 ± 8 | 80 ± 6 | 80 ± 4 |
| copolymer [wt %] | | | | | | | | |
| 2^{nd} ethylene-propylene | 16 ± 14 | 16 ± 12 | 16 ± 10 | 16 ± 8 | 16 ± 6 | 16 ± 4 | 16 ± 2 | 16 ± 2 |
| copolymer [wt %] | | | | | | | | |
| Further layer | | | | | | | | |
| Layer thickness [μm]: | 17 ± 15 | 17 ± 15 | 17 ± 15 | 17 ± 10 | 17 ± 10 | 17 ± 10 | 17 ± 5 | 17 ± 5 |
| 1^{st} ethylene-propylene | 66 ± 20 | 66 ± 18 | 66 ± 16 | 66 ± 14 | 66 ± 12 | 66 ± 10 | 66 ± 8 | 66 ± 6 |
| copolymer [wt %] | | | | | | | | |
| 2^{nd} ethylene-propylene | 27 ± 20 | 27 ± 18 | 27 ± 16 | 27 ± 14 | 27 ± 12 | 27 ± 10 | 27 ± 8 | 27 ± 6 |
| copolymer [wt %] | | | | | | | | |
| | V⁹ | V¹⁰ | V¹¹ | V¹² | V¹³ | V¹⁴ | V¹⁵ | V¹⁶ |
| Coating material | | | | | | | | |
| Layer thickness [μm]: | 40 ± 30 | 40 ± 30 | 40 ± 20 | 40 ± 20 | 40 ± 15 | 40 ± 15 | 40 ± 10 | 40 ± 10 |
| Polyurethane varnish | 95 ± 5 | 95 ± 5 | 95 ± 5 | 95 ± 5 | 95 ± 5 | 95 ± 5 | 95 ± 5 | 95 ± 5 |
| [wt %] | | | | | | | | |
| Adhesion-modified layer | | | | | | | | |
| Layer thickness [μm]: | 17 ± 15 | 17 ± 15 | 17 ± 15 | 17 ± 10 | 17 ± 10 | 17 ± 10 | 17 ± 5 | 17 ± 5 |
| rTPO [wt %] | 66 ± 20 | 66 ± 18 | 66 ± 16 | 66 ± 14 | 66 ± 12 | 66 ± 10 | 66 ± 8 | 66 ± 6 |
| Adhesion promoter | 27 ± 20 | 27 ± 18 | 27 ± 16 | 27 ± 14 | 27 ± 12 | 27 ± 10 | 27 ± 8 | 27 ± 6 |
| [wt %] | | | | | | | | |
| Core layer | | | | | | | | |
| Layer thickness [μm]: | 26 ± 25 | 26 ± 25 | 26 ± 25 | 26 ± 20 | 26 ± 20 | 26 ± 20 | 26 ± 15 | 26 ± 15 |
| rTPO [wt %] | 80 ± 18 | 80 ± 16 | 80 ± 14 | 80 ± 12 | 80 ± 10 | 80 ± 8 | 80 ± 6 | 80 ± 4 |
| HeCo PP [wt %] | 16 ± 14 | 16 ± 12 | 16 ± 10 | 16 ± 8 | 16 ± 6 | 16 ± 4 | 16 ± 2 | 16 ± 2 |
| Further layer | | | | | | | | |
| Layer thickness [μm]: | 17 ± 15 | 17 ± 15 | 17 ± 15 | 17 ± 10 | 17 ± 10 | 17 ± 10 | 17 ± 5 | 17 ± 5 |
| rTPO [wt %] | 66 ± 20 | 66 ± 18 | 66 ± 16 | 66 ± 14 | 66 ± 12 | 66 ± 10 | 66 ± 8 | 66 ± 6 |
| HeCo PP [wt %] | 27 ± 20 | 27 ± 18 | 27 ± 16 | 27 ± 14 | 27 ± 12 | 27 ± 10 | 27 ± 8 | 27 ± 6 |

A further aspect of the invention relates to a method for producing the above-described polymeric film of the invention for coating plastics moldings, comprising the steps of:
(a-1) providing a film comprising an adhesion-modified layer which forms at least one of the two outer sides of the film;
(a-2) wholly or partly coating the outer side with a coating material, preferably with a curable coating material in a curable state; and
(a-3) drying and/or curing the coating material, preferably thermally.

All preferred embodiments described above in connection with the polymeric film of the invention are also valid analogously for the method of the invention.

A further aspect of the invention relates to a method for coating plastics moldings with a coating material, comprising the steps of
(a) providing an above-described polymeric film of the invention;
(b) forming the polymeric film, preferably at room temperature, preferably in a mold for producing plastics moldings;
(c) contacting the coating material with a curable plastics composition; and
(d) curing the plastics composition;
   where the bond adhesion of the coating material to the cured composition is greater than the bond adhesion of the coating material to the adhesion-modified layer of the polymeric film.

All preferred embodiments described above in connection with the polymeric film of the invention and with the method of the invention for producing said polymeric film are also valid analogously for the method of the invention for coating plastics moldings with a coating material.

The curable composition is preferably a polyurethane foam.

A further aspect of the invention relates to the use of the above-described polymeric film of the invention for coating a plastics molding with the coating material, where the use takes place preferably in the above-described method of the invention for coating plastics moldings with a coating material.

All preferred embodiments described above in connection with the polymeric film of the invention and also with the two methods of the invention are also valid analogously for the use according to the invention.

In an embodiment of the invention particularly preferred in the invention,
the adhesion-modified layer comprises as polyolefin a heterophasic ethylene-propylene copolymer, more preferably an rTPO, and comprises as adhesion promoter a maleic anhydride-grafted polypropylene;
the coating material comprises a polyurethane varnish; and
the curable plastics composition, i.e., the material of the plastics molding, comprises a polyurethane foam.

### BRIEF DESCRIPTION OF THE DRAWINGS

The invention is elucidated schematically below with FIGS. 1 to 6.

FIG. 1 shows schematically a preferred embodiment of the polymeric film of the invention, with layer of coating material (1), adhesion-modified layer (2), core layer (3) and further layer (4) in the as yet unformed state.

FIG. 2 shows schematically how the polymeric film of the invention as per FIG. 1 is applied to a mold (5) for producing plastics moldings and is given an airtight seal at the edges. The mold (5) thus forms, together with the polymeric film, a cavity, with the further layer (4) facing the interior of the cavity.

FIG. 3 shows schematically the polymeric film as per FIG. 2 after having been formed in the mold (5), so that the formed polymeric film conforms to the inner surface of the mold (5). The further layer (4) of the polymeric film in this case touches the inner surface of the mold (5). The layer of coating material (1) is facing the interior of the shape produced by forming.

FIG. 4 shows the production of a plastics molding (6) from a curable plastics composition in the interior of the shape produced by the forming, by injection of a polyurethane foam, for example.

FIG. 5 shows the plastics molding (6), removed from the mold (5) (not depicted), after the plastics composition has cured. Because the adhesion of the further layer (4) to the inner surface of the mold (5) (not depicted) is low, the plastics molding (6) can be removed without residue together with the adhering layer of the coating material (1) and the other layers of the polymeric film. In this state the polymeric film protects the plastics molding (6) together with the coating material layer (1) adhering thereto.

FIG. 6 shows schematically how the polymeric film can be peeled from the plastics molding (6) without the layer of the coating material (1). Because the adhesion of the coating material (1) to the plastics molding (6) is stronger than the adhesion of the coating material (1) to the adhesion-modified layer (2) of the polymeric film, the split takes place between the layer of the coating material (1) and the adhesion-modified layer (2). The coating material (1) therefore remains on the plastics molding (6), and the outer surface of the coating material is exposed without residue. In this way the coating material (1) has been transferred from the polymeric film to the plastics molding (6).

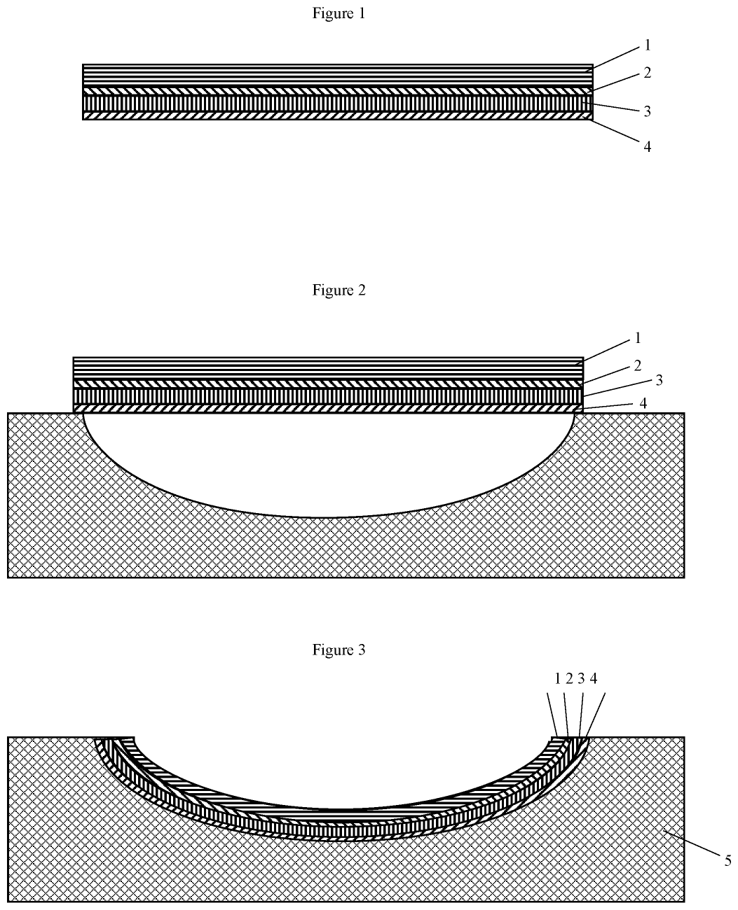

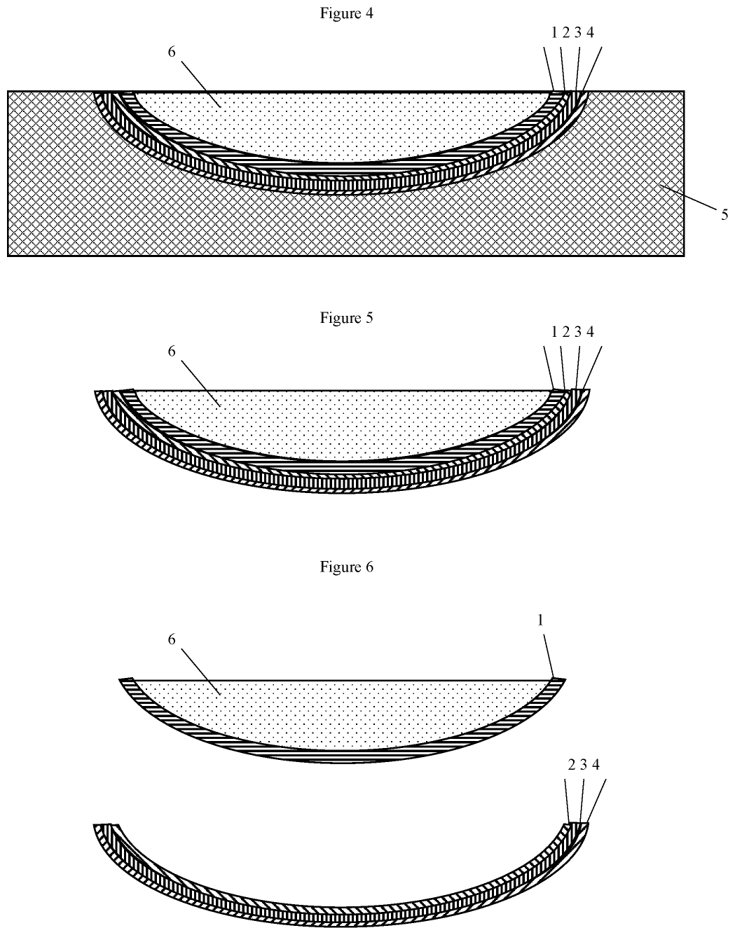

### LIST OF REFERENCE NUMERALS

(1)—layer of coating material
(2)—adhesion-modified layer
(3)—core layer
(4)—further layer
(5)—mold
(6)—plastics molding

The examples which follow elucidate the invention, but should not be interpreted limitingly.

Three different polymeric films were produced respectively from three layers, with a total film thickness (without coating material) of 60 μm. The composition of the adhesion-modified layer was varied in terms of the amount of adhesion promoter; all other parameters were kept constant.

The polymeric films thus produced were coated on the surface of the adhesion-modified layer (first outer side) with a commercially available 2-component polyurethane varnish as coating material. To produce the sample strips, the 2-component polyurethane varnish was applied by knife coating to a sheet in DIN A4 format of the polymeric film, in an amount such that the layer thickness of the varnish after drying in a forced air oven was 40 μm.

After the curing/drying of the polyurethane varnish (coating material), determinations were made of the release forces between the adhesion-modified layer and the coating material. The film construction and the release forces measured are collated in the table below:

| | 1 | 2 | 3 |
|---|---|---|---|
| Adhesion-modified layer (first outer | | | |
| side) | | | |
| Layer thickness: | 17 μm | 17 μm | 17 μm |
| rTPO (Adflex ® Q 100 F) | 92.3% | 65.3% | 50% |
| Adhesion promoter (Admer QB 520 E) | 0% | 27% | 50% |
| Additives (UV stabilizer, antiblocking | 7.7% | 7.7% | 7.7% |
| agent, processing aid) | | | |
| Core layer | | | |
| Layer thickness: | 26 μm | 26 μm | 26 μm |
| rTPO (Adflex ® Q 100 F) | 80% | 80% | 80% |
| HeCo PP (Inspire ® D137) | 16% | 16% | 16% |
| Additives (UV stabilizer, dye) | 4% | 4% | 4% |
| Further layer (second outer side) | | | |
| Layer thickness: | 17 μm | 17 μm | 17 μm |
| rTPO (Adflex ® Q 100 F) | 65.3% | 65.3% | 65.3% |
| HeCo PP (Inspire ® D137) | 27% | 27% | 27% |
| Additives (UV stabilizer, antiblocking | 7.7% | 7.7% | 7.7% |
| agent, processing aid) | | | |
| Release force [cN/cm] | 2.0 ± 0.1 | 4.0 ± 0.3 | 5.3 ± 0.3 |

The release forces were determined in a method based on the Finat test method (without storage) on strips with a width of 40 mm of the sheet in DIN A4 format, by means of a model Z0.5 tensile testing machine from Zwick/Roell. Measurement took place on sets of three strips. The strips were adhered by the varnish side to a metal support plate furnished with a double-sided adhesive tape (CMC 10730). The metal support plate was introduced into the bottom clamping jaw of the test apparatus, and the film was parted from varnish at a lower edge adhered to a stiff film strip, which was introduced into the upper clamping jaw. The measurement took place at 300 mm/min.

1. A polymeric film for coating plastics moldings with a coating material, where the polymeric film comprises an adhesion-modified layer and a layer of the coating material;
where the polymeric film is formable at room temperature;
where the coating material wholly or partly covers the adhesion-modified layer;
where the adhesion-modified layer has a layer thickness of at least 1.0 μm, is in direct contact with the coating material, and
(i) has a surface energy, on its surface side facing the coating material, of at least 27 mN/m; and
(ii) is based on a mixture which comprises at least one polyolefin and at least (a) one adhesion promoter, (b) one thermoplastic elastomer or (c) one polyamide alloy.

2. The polymeric film of claim 1, where the coating material
has been produced from a curable composition; and/or
is in the cured state.

3. The polymeric film of claim 1, where the coating material is a varnish.

4. The polymeric film of claim 3, where the varnish
is a thermosetting varnish; and/or
is based on polyurethane, polyacrylate or epoxide.

5. The polymeric film of claim 1, where the coating material
at 23° C. has an elongation at break of at least 100%; and/or
forms one of the two outer sides of the polymeric film; and/or
has a layer thickness of at least 5 μm.

6. The polymeric film of claim 1, where the surface side of the adhesion-modified layer that faces the coating material has not been surface-activated.

7. The polymeric film of claim 1, where the polymers or polymer mixtures in all layers have in each case a melting temperature of at least 110° C., determined by DSC according to DIN EN ISO 11357-3:2018-07.

8. The polymeric film of claim 1, where the adhesion-modified layer, on its surface side facing the coating material, has a surface energy of at most 45 mN/m.

9. The polymeric film of claim 1, where the adhesion-modified layer is based on a mixture which comprises at least one polyolefin and at least one adhesion promoter, where
(i) the adhesion promoter is selected from acid anhydride-modified polyolefins, hydroxyl-modified polyolefins, acid-modified polyolefins, acetate-modified polyolefins and epoxy-modified polyolefins; and/or
(ii) the weight fraction of the adhesion promoter is in the range from 10 wt % to 65 wt %, based on the total weight of the adhesion-modified layer; and/or
(iii) the at least one polyolefin is selected from the group consisting of polyethylene homopolymer, polyethylene copolymer, polypropylene homopolymer and polypropylene copolymer.

10. The polymeric film of claim 1, where the adhesion-modified layer is based on a mixture which comprises at least one polyolefin and at least one thermoplastic elastomer, where
(i) the thermoplastic elastomer is selected from thermoplastic copolyesters elastomers, thermoplastic polyamide elastomers and thermoplastic polyurethane elastomers; and/or
(ii) the weight fraction of the thermoplastic elastomer is in the range from 1.0 wt % to 35 wt %, based on the total weight of the adhesion-modified layer; and/or
(iii) the at least one polyolefin is selected from the group consisting of polyethylene homopolymer, polyethylene copolymer, polypropylene homopolymer and polypropylene copolymer.

11. The polymeric film of claim 10, where the adhesion-modified layer further comprises at least one compatibilizer, where
(i) the compatibilizer is selected from ethylene-acrylate copolymers, MAH grafted ethylene-acrylate copolymers and ethylene-acrylate-glycidyl methacrylate terpolymers; and/or
(ii) the weight fraction of the compatibilizer is in the range from 1.0 wt % to 20 wt %, based on the total weight of the adhesion-modified layer.

12. The polymeric film of claim 1, where the adhesion-modified layer is based on a mixture which comprises at least one polyolefin and at least one polyamide alloy, where
(i) the polyamide alloy is a polyamide-based thermoplastic alloy; and/or
(ii) the weight fraction of the polyamide alloy is in the range from 10 wt % to 60 wt %, based on the total weight of the adhesion-modified layer; and/or
(iii) the at least one polyolefin is selected from the group consisting of polyethylene homopolymer, polyethylene copolymer, polypropylene homopolymer and polypropylene copolymer.

13. The polymeric film of claim 1, which as well as the adhesion-modified layer and the layer of the coating material comprises a further layer.

14. The polymeric film of claim 13, where the further layer
is disposed on that surface side of the adhesion-modified layer that faces away from the coating material; and/or
forms one of the two outer sides of the polymeric film; and/or
is furnished with release properties on its surface side facing away from the adhesion-modified layer.

15. The polymeric film of claim 1, which has a total layer thickness of at least 30 μm.

16. The polymeric film of claim 1, which has at room temperature an elongation at break of at least 100%.

17. The polymeric film of claim 1, which is embossed on at least one side.

18. A method for producing a polymeric film for coating plastics moldings with a coating material of claim 1, comprising the steps of:
(a-1) providing a film comprising an adhesion-modified layer which forms at least one of the two outer sides of the film;
(a-2) wholly or partly coating the outer side with a coating material; and
(a-3) drying and/or curing the coating material.

19. A method for coating plastics moldings with a coating material, comprising the steps of
(a) providing a polymeric film of claim 1;
(b) forming the polymeric film, optionally at room temperature;
(c) contacting the coating material with a curable plastics composition; and
(d) curing the plastics composition;
where the bond adhesion of the coating material to the cured composition is greater than the bond adhesion of the coating material to the adhesion-modified layer of the polymeric film;
optionally wherein the curable composition is a polyurethane foam.

20. (canceled)

21. An article comprising a plastics molding coated with the coating material of the polymeric film of claim 1.

22. (canceled)
